(19) United States
(12) Patent Application Publication
(10) Pub. No.: US 2025/0246333 A1
(43) Pub. Date: Jul. 31, 2025

(54) PREPARATION OF HIGH SPECIFIC ACTIVITY PT ISOTOPES FROM IR ALLOYS

(71) Applicant: STICHTING NUCLEAR RESEARCH AND CONSULTANCY GROUP, Petten (NL)

(72) Inventors: Sander DE GROOT, Le Petten (NL); Arend BOOIJ, Le Petten (NL); Klaas BAKKER, Le Petten (NL); Karlijn CODÉE-VAN DER SCHILDE, Le Petten (NL)

(21) Appl. No.: 19/078,001

(22) Filed: Mar. 12, 2025

Related U.S. Application Data
(63) Continuation of application No. PCT/EP2023/072728, filed on Aug. 17, 2023.

(30) Foreign Application Priority Data
Sep. 13, 2022 (EP) 22195397.9

(51) Int. Cl. G21G 1/06; G21G 1/00

(52) U.S. Cl. CPC G21G 1/06; G21G 2001/0094

(57) ABSTRACT

Disclosed is a process for the production of platinum isotopes from iridium comprising the steps of providing a mixture, preferably an atomic dispersion of a carrier material such as Al and iridium (Ir), subjecting the carrier material-Ir mixture to a neutron flux to thereby generate an irradiated carrier material-Ir mixture comprising platinum (Pt) isotopes, isolating Pt isotopes from the irradiated carrier material-Ir mixture.

### CROSS-REFERENCE TO RELATED APPLICATIONS

The present application is a continuation application of PCT/EP2023/072728 filed Aug. 17, 2023, which claims priority to EP 22195397.9 filed Sep. 13, 2022, the entire contents of all of which are incorporated herein by reference.

### FIELD OF THE INVENTION

The present invention pertains to a method for the preparation of platinum isotopes from iridium-containing starting materials. The invention further relates to platinum isotopes having high specific activity. The invention further relates to the use of platinum isotopes in radiotherapeutic and/or diagnostic applications.

### BACKGROUND OF THE INVENTION

Certain Auger emitting isotopes have found practical application in radiotherapy. Due to the very small damage range of Auger emitters, effective treatment requires the Auger emitter to be located near or at vital locations in a cancer cell, for example at the cell membrane or at the cell nucleus (DNA) or mitochondrial DNA-RNA. In that case Auger emitters can be very effective in killing the cell.

If not at the right location, Auger emission hardly creates any severe irreparable damage to cells, even if located inside the cell. Auger emission in a cell does not lead to damage to surrounding cells or tissue. Therefore a proper targeting compound that specifically brings an Auger emitter to the right location in cancer cells, will have the perspective of effective treatment with small or no side effects.

The platinum isotope ^{195m}pt appears to combine the desired functionalities. Pt has a chemical affinity to bind to DNA, which has been exploited already for decades by platinum based cancer therapies, like chemotherapy. Furthermore ^{195m}pt emits gamma rays that can be useful for SPECT-imaging. The combination of the Auger emitter ^{195m}pt, and the chemical behaviour of platinum, can make this an ideal isotope for eliminating cancer cells with the potential of minimized damage to healthy cells (i.e. limited to no side effects). Pt-compounds that combine cancer cell-targeting with in-cell chemical bonding of Pt to cell-DNA can be especially successful for cancer treatment.

The production route of ^{195m}Pt is known, but it is difficult to produce ^{195m}Pt in clinically relevant amounts, of sufficiently high specific activity for therapeutic efficiency and efficiently enough to cope with the half-life (about 4 days) of the isotope for successful radiotherapeutic application.

The standard carrier-added route by neutron source, in which ¹⁹⁴Pt ((n,γ)-reaction)) or ¹⁹⁵Pt ((n,2n)- or (γ,n)-reaction, including thermal neutron shielding to maximize yield by avoiding ^{195m}Pt high cross-section burn-up), provides significant specific activities, experimentally determined by irradiation in the HFR Petten, which could be adequate for diagnostic applications, also providing relatively high radionuclidic purity. For therapeutic application however, much higher and preferably maximized specific activities will be required. For this a ‘non-carrier added’ route is necessary, for example via the neutron irradiation and (double neutron) activation of ¹⁹³Ir.

For the non-carrier route via ¹⁹³Ir neutron irradiation, a process for the generation of high specific activity Pt isotopes such as ^{195m}pt is described in WO2004015718A1. In WO2004015718A1 ^{195m}Pt is produced by neutron activation of ¹⁹³Ir, which subsequently generates ¹⁹⁴Ir, and subsequent neutron activation of ¹⁹⁴Ir, which then generates ^{195m}Ir, which decays to ^{195m}Pt. After irradiation in reactor of an iridium target enriched in ¹⁹³Ir, the platinum isotopes are chemically separated from the iridium isotopes, rendering [^{195m}Pt]-Pt. The use of iridium enriched in ¹⁹³Ir has several advantages:
Higher yield of ^{195m}pt per gram iridium.
Higher specific activity of the ^{195m}pt.
Unwanted by-products by the activation of the other stable ¹⁹¹Ir isotope, which is present in larger amounts with lower ¹⁹³Ir enrichment levels, such as ¹⁹²Ir, which is a long-lived isotope that complicates the handling of the irradiated target and the recycling of the used target material, and the generation of other platinum isotopes, either stable (decreasing the specific activity) or unwanted (decreasing the radionuclidic purity of the end product).

There are however some problems associated with this method.

Iridium-isotopes have a quite significant neutron absorption cross-section, which leads to neutron self-shielding: in a solid Iridium mass under neutron bombardment, Iridium on the outside of the target will absorb most of the neutrons, causing the inside to be exposed to less neutrons, which reduces the amount of Pt that can be formed by neutron activation. A lower Iridium density irradiation target would therefore be desirable, such that all of the Iridium is exposed to a similar high neutron flux to maximize the amount of Pt generated per unit mass of Iridium. The use of costly enriched ¹⁹³Ir can thus be reduced, and the concentration of Pt-isotopes is increased, which can also increase extraction efficiency.

While radioactive platinum isotopes generally emit low energy radiation, highly active and high gamma energy emitting Iridium isotopes are formed during irradiation. These need to be handled as part of the post-irradiation Pt extraction process. The radiation intensity generated by especially the Iridium isotopes complicates handling and requires heavy shielded infrastructure (transport containers, hot cells, local shielding) to avoid unacceptable worker dose, risk of release of radioactivity, and handling hazards.

One step in the production of Pt isotopes from iridium is dissolution of the irradiated target. Iridium metal is notoriously difficult to dissolve. After irradiation the dissolution process is complicated by the intense radiation produced by the iridium isotopes formed, while processing and separation preferably takes place as soon as possible after irradiation to avoid the loss of ^{195m}pt activity, and ingrowth of other (unwanted) Pt-isotopes from Iridium reducing ^{195m}Pt specific activity. A complicated dissolution process therefore needs to be avoided, and the same applies to follow-up steps regarding the separation and purification of the [^{195m}Pt]-Pt. WO2004015718A1 proposes long duration exposure to high pressure and temperature to dissolve the iridium, which is difficult to practically and safely achieve in a nuclear (radiation shielded) environment with large amounts of high energy activity. There is a need for a simplified and practical method for the generation of Pt isotopes from Iridium.

### SUMMARY OF THE INVENTION

The present inventors have found that a platinum isotope, especially ^{195m}pt, can be prepared with high specific activity and can be prepared conveniently and efficiently by providing a target of a carrier material/iridium mixture, irradiating the mixture with neutrons to induce the formation of platinum isotopes, facilitating dissolution of the target post irradiation, and subsequent isolation of the platinum isotopes by extraction, separation and/or purification processes.

Thus, in a first aspect there is provided a method for the production of platinum isotopes from iridium comprising the steps of
providing a mixture of a carrier material and iridium (Ir);
subjecting the carrier material-Ir mixture to a neutron flux to thereby generate an irradiated carrier material-Ir mixture comprising platinum (Pt) isotopes;
isolating Pt isotopes from the irradiated carrier material-Ir mixture.

### BRIEF DESCRIPTION OF THE FIGURES

FIG. 1: Percentage of accumulative recovered Al, Ir and Pt after treatment of bead (2.5% Ir) with 37% HCl & aqua regia at different time intervals. (Lowest recovery).

FIG. 2: Percentage of recovered Al, Ir and Pt after treatment of bead (2.5% Ir) with 37% HCl & aqua regia at different time intervals. (Highest recovery).

### DETAILED DESCRIPTION OF THE INVENTION

In a first aspect, the invention pertains to a method for the production of platinum isotopes from iridium comprising the steps of
providing a mixture of a carrier material and (enriched) iridium (Ir);
subjecting the carrier material-Ir mixture to a neutron flux to thereby generate an irradiated carrier material-Ir mixture comprising platinum (Pt) isotopes;
dissolution of the target post irradiation and isolating Pt isotopes from the irradiated carrier material-Ir mixture.

The invention includes the use of a carrier material-iridium mixture as an irradiation target. The carrier material can be selected from a large group of materials and mixtures thereof, provided that these allow and conveniently enable atomic, atom cluster, or small particle distribution of Iridium in the carrier material for example by heating and/or melting, have a reasonable thermal conductivity (to avoid too high temperatures and temperature gradients in the target under irradiation), have a low neutron absorption cross-section to avoid self-shielding and reduce the overall Iridium target self-shielding, avoid the formation of problematic long-lived and/or high gamma energy neutron activation products, are conveniently dissolvable, and have high evaporation temperatures (to avoid potential pressurisation issues under irradiation).

The carrier material can preferably be selected from the group consisting of Al, Zr, Ti, In, Si, V, Sc, Mg, Ca, Pb and mixtures thereof, preferably Al, Ti or Zr and mixtures thereof. The carrier material may be isotopically enriched, to avoid, limit or reduce certain neutron activation reactions.

The carrier material-Ir mixture is a dispersion, preferably an atomic dispersion, of Ir in the carrier material. The Ir metal may be present as particles in the carrier material-iridium mixture. The average particle size or inclusion size of the Ir particles in the carrier material-iridium mixture is preferable less than 500 micron, preferably less than 100 micron, more preferably less than 10 micron, even more preferably less than 1 micron. By having the iridium present in the mixture as small particles in a bulk of low neutron absorption cross-section carrier material, neutron radiation self-shielding by the target mass can be reduced and/or avoided. Shielding occurs when iridium atoms are shielded from neutrons by surrounding (iridium) atoms.

This avoidance of shielding can be avoided further in embodiments of the invention wherein the carrier material iridium mixture is provided in a shape that prevents or reduces shielding by high surface to volume ratio's, such as a (thin) wire, bar, a plate, a foil etc.

In certain embodiments, the carrier material-Ir mixture can be provided as an alloy or a compound of Ir and the carrier material, and preferably a metallic compound such as an iridide. An iridide is an intermetallic alloy that, in the case of Al contains aluminumiridides (Alⁿ⁺+Irⁿ⁻) which, due to their unique ionogenic character, are more soluble than Ir(0) and therefore more easily release Pt(0) to solution. It is hence preferred to maximize iridide formation in the target. For other carrier materials, similar intermetallic alloys that may or not may not be ionogenic exist and can be formed and are of similar advantageous use. In an alternative embodiment, the carrier material-Ir mixture can be prepared by coprecipitating the carrier material and Ir together, preferably by coprecipitation from solution.

The irradiation target can be manufactured by heat treatment or melting of iridium and carrier material together, for instance by heating in an oven, by welding, by induction or electromagnetic radiation, laser, (TIG) welding, re-welding following the same procedure, repetitive heat treatments, possibly in combination with source material generated by the co-precipitation of pre-dissolved Ir and carrier material, or other methods to maximize dispersion of Ir in the carrier material. By this procedure, in the case of aluminium, aluminium-iridites can be formed, which may cause the iridium to be dispersed in the aluminium at atomic level and hence be preferred. Similar compounds between Iridium and the carrier material can be foreseen, which facilitate Ir-dispersion at atomic or small particle level in the carrier material mass. Alternative manufacturing methods may be using electrical induction.

Providing the Ir in a dispersion of a carrier material can have a number of advantages. Combining iridium with a large amount of carrier material, that has a relatively small neutron absorption cross-section, the effective Iridium density in the target can significantly lowered. Neutron self-shielding is therefore reduced, maximizing the activation of Iridium and the production of ^{195m}Pt. In this way ^{195m}pt-content can be maximized, the specific activity can be higher and/or enriched ¹⁹³Ir quantities required are minimized.

Carrier material-iridium metal alloys, such as Al—Ir, are less likely to dissociate, form gaseous products during neutron irradiation, or significantly change under neutron irradiation, which allows the target to be irradiated directly, without safety concerns and without complicated target conditioning or containment measures. Carrier material-iridium alloys or soluble carrier material-Ir compounds therefore form target material which is well suited for neutron irradiation (in reactor for example). Also the workup to isolate the desired Pt-isotope is greatly enhanced: Iridium itself is difficult to bring into solution and typically requires harsh circumstances such as very high temperatures, aggressive dissolution fluids and/or high pressures. Bringing Iridium into solution is greatly facilitated when it is dispersed in a carrier material such as an Al or Zr-matrix. Dissolving Ir dispersed in a carrier material matrix is usually quick (hours) and can be executed with standard, small and simple equipment. Complex, hazardous and time consuming procedures with very high activity material, and the safety hazard and worker dose issues associated, can thus be managed, mitigated and/or avoided when using carrier material-iridium mixtures, and a relatively small and simple non-pressurized dissolution (and subsequent separation/purification) set up can be used.

The present invention facilitates and improves the production of high specific activity [^{195m}pt]-Pt: a radio-isotope with great perspective largely unexplored by lack of availability due to production complexity. The invention provides a convenient and safe target for neutron irradiation, that maximizes Pt-production by reduction of self-shielding, and greatly facilitates and simplifies the dissolution and the post-irradiation Pt-extraction/purification process. The present invention allows for a simple preparative set-up to bring the formed Pt into solution, and after conditioning can be brought on to a chemical separation column directly. The (non)-radiating carrier material remnants and iridium isotopes can be separated off, and the desired Pt collected. The set-up can be small, and executed with simple automation (pump, some valves, tubing and a small column will suffice), which enables safe and convenient introduction into a radiation shielded environment, and simplicity and small volume of the set-up also facilitates the use of (additional) local shielding. The column with the Pt can be taken out, and used for further purification and radiochemical/radiopharmaceutical production processing, with the safety concerns of handling high energy gamma emitting radioisotopes and iridium isotopes eliminated.

The amount of Ir in the mixture can be from 0.5 to 50 wt. % calculated on the total weight of the mixture. Relevant factor in this respect is the level of self-shielding reduced by large volumes of carrier material, the ease of target manufacture in which the Iridium needs to be dispersed in as small particles (preferably atomically) in the carrier material and the ease of dissolution of the Iridium, Platinum generated and carrier material, and subsequent separation/purification. In embodiments, the amount of Ir in the mixture is lower than 50, preferably lower than 10, with a higher preference lower than 3. In preferred embodiments it can be more than 1, preferably more than 2 wt. %.

The amount of carrier material in the carrier material-iridium can be adjusted in a similar manner. Thus, the amount of carrier material in the mixture can be from 50 to 99.5 wt. % calculated on the total weight of the mixture. In embodiments, the amount of carrier material in the mixture is more than 50, preferably more than 60, with a higher preference more than 70. In preferred embodiment it can be more than 80, preferably more than 90 wt. %, even more preferred more than 97 wt. %.

In preferred embodiments, the iridium is enriched in ¹⁹³Ir. Enrichment of iridium can be achieved with methods known in the art. Preferably the ¹⁹³Ir is highly enriched (>95%, or preferably >99%), to avoid generation of high activity Ir-isotopes and unwanted Pt-isotopes. The irradiated product obtained from irradiation of the carrier material iridium mixture can subsequently be treated to separate the products comprising isotopes such as ^{195m}pt and/or other Pt isotope from the product. The carrier material can be removed from the irradiated product, for instance by melting and/or dissolution followed by separation. Alternatively the irradiated product is extracted with an extraction solvent to allow separating it into various components, such as carrier material, unconverted iridium and products from the irradiation process such as platina isotopes.

The extraction solvent is preferably capable of dissolving at least one or more of the components selectively. In this way, for instance the carrier material may be leached out of the irradiated product, leaving the unconverted iridium and any product for further workup. In case of adequately small dispersion of the Iridium, and high carrier material content, the Pt-isotopes generated could be located in the carrier material mass, due to recoil after decay when the Iridium isotope is activated, which would allow extraction of the Pt from the carrier material more than from Iridium, facilitating the extraction process, as Iridium does not require to be dissolved. The extraction solvent may also be capable of dissolving all components which can then be followed by a separation step, which can involve chromatography, ion exchange column or electrochemical separation.

The extraction solvent can be selected from the group consisting of strong (mineral) acids and strong lyes (alkaline solutions). Aluminum will dissolve in strong lye. This can be a first step, followed by separation of the dissolved aluminum and the unconverted iridium and products like Pt isotopes. There is a higher preference for strong mineral acids since they dissolve most metals. Particularly preferred are acid and acidic mixture such as HCl, NaBrO3/HCl, H2O2/HCl and HCL/HNO3 (aqua regia) and mixtures thereof, preferably aqua regia. The metals will typically be an (partial) ionized form. This facilitates later separation, for instance by selective precipitation, ion exchange, chromatography and/or electrochemical methods.

To further aid in the dissolution process of the metals, the (aqueous) dissolution of the irradiated product can be performed at a temperature of from 20° C. up to 120° C., preferably between 3° and 90° C.

The irradiation target material in solution, which may comprises one or more of ^{195m}-Pt, other Pt isotopes, carrier material (such as aluminum or zirconium or silicon and as mentioned in here elsewhere) and iridium can be separated into its components to isolate and/or purify the desired product such as Pt isotopes, preferably ^{195m}Pt by (column) chromatography, ion exchange and/or electrochemical methods. Using (column) chromatography, the component of the irradiated product can be separated. In embodiments, components can be selectively eluted, for instance by using (gradient) eluents or successive eluents that have a different pH to elute the undesired component while maintaining the desired isotope on the column or vice versa, selectively eluting the desired (^{195m}) Pt isotope selectively. Example of such processes have been described in for instance WO2004015718A1 and can be determined by the skilled person.

The result of the present method of the invention is [^{195m}Pt]-Pt. The [^{195m}Pt]-Pt has a specific activity that can be in the order of 13-17 GBq ^{195m}Pt end of irradiation per mg Pt (all Pt isotopes generated).

### EXAMPLES

All % are wt. % unless otherwise stated and calculated based on total composition. All chemicals are available from commercial vendors and were used as such unless otherwise stated.

### Example 1: Preparation of Al/Ir and Al/Ir/Pt Beads

Aluminium, iridium and platinum were weighed off on respectively a regular- and microbalance. Ratios of 97.5% Al 2.50% Ir; Ir 97.5% Al 2.25% Ir 0.25% Pt; and 95,0% Al 4.50% Ir 0.50% Pt were chosen as representative, each with a total weight of 100 mg. Generally, aluminium powder was weighed off on a normal balance, followed by addition of iridium. Pt mesh wire was cut and weighed on a microbalance and then added. The components were then transferred to a mould after which a tablet was pressed at 500 kg. Tablets prepared by the hydraulic press were welded using a Tungsten Inert Gas welder with a flow rate of 2 L argon min⁻¹, at 47A with 11,7V Direct Current (DC) or 53A. The tablet was placed in a custom (copper or tungsten) mold and welded for 15 seconds on each side, with cooling for ˜15 s between steps. Rewelding was performed to increase the amount of the alloy of aluminum and iridium aiding the solubility of iridium. Both Al/Ir/Pt and Al/Ir beads were made to evaluate the beads prior and after irradiation and before doing any hot experiments (i.e. with irradiated materials).

Beads were also prepared with zirconium, with a similar weight distribution, replacing the Aluminium with Zirconium, showing the same performance and homogeneous target formation. To secure full melting, a longer welding time and more welding steps were adopted.

### Experiment 2: Extraction of Ir and/or Pt

The following extraction experiments were performed:

2.1 Extraction of iridium from IrO₂ (s) powder at high temperature in aqua regia

IrO₂ powder (99+%) was suspended in aqua regia and refluxed at high temperature in a reflux setup in aqua regia (3:1 mol ratio 65% HNO₃ & 37% HCl) for 24 h. Aliquots—small samples—were taken at 4 h and 24 h. ICP-OES experiments show that less than 1 percent of iridium could be recovered after this period.

2.2. Extraction of iridium from Ir(s) powder at high temperature using aqua regia Ir powder (99+% purity) was suspended in aqua regia and refluxed at high temperature in a reflux setup in aqua regia (32 mL, 3:1 mol ratio 65% HNO₃ & 37% HCl) for 48 h. ICP-OES analysis demonstrates that 0.24% of iridium could be recovered after this period.

2.3. Extraction of iridium from Ir(s) powder at high temperature and high pressure using aqua regia in an acid digestion vessel by Parr®.

Several experiments were carried out with metallic Ir(s) powder (99+%) and aqua regia (molar ratio: 10:1; 37% HCl & 65% HNO₃) with an Acid Digestion Vessel (ADV) using a 5 mL cup at different reaction times (0.25 h-5 h) and temperatures (160 & 217° C.) using a standard oven. None of the conditions allowed for a satisfactory recovery of iridium; less than 1% could be recovered after treatment with aqua regia.

2.4. Extraction of iridium and platinum from Al/Ir/Pt beads at room temperature using NaBrO₃/HCl, H₂O₂/HCl and aqua regia.

Al/Ir and Al/Ir/Pt beads (prepared by TIG welding) with a composition of either 5 or 2,5% of iridium in aluminum and 0.25% Pt with a diameter of 3,77 or 3.94 mm were treated with HCl followed by treatment with aqua regia, H₂O₂/HCl or HCl/NaBrO₃ (aq) in a 15 mL centrifugal tube without stirring at room temperature (rt) as shown in Table 1. Typically beads have dimensions in the mm range (1-10 mm).

TABLE 1
Overview of reaction conditions used during the leaching experiments
for the recovery of iridium and platinum from 2.5% and 5.0% target
beads. Beads were treated # times with HCl for 5 min, followed by # times
with either aqua regia, H₂O₂/HCl or HCl/NaBrO₃.

| 5 min/# | 10 min/# | T in ° C. | Ir (%) | Al (%) | Ir (%) | Pt (%) |
|---|---|---|---|---|---|---|
| 3 × HCl | 3 × Aqua Regia | Rt | 2.5 (quadruplo) | 88-91 | 8-11 | 16-19 |
| 3 × HCl | 3 × H₂O₂/HCl | Rt | 2.5 (duplo) | 28-82 | 1-2 | 1-3 |
| 3 × HCl | 3 × H₂O₂/HCl | Rt | 5 (duplo) | 10-23 | 1-2 | 2-3 |
| 3 × HCl | 3 × NaBrO₃ | Rt | 5.0 (duplo) | 21-22 | 4-6 | 5-9 |
| 3 × HCl | 3 × Aqua Regia | 50° C. | 2.5 (duplo) | 150-157 | 16-17 | 14-27 |
| 3 × HCl | 3 × H₂O₂/HCl | 50° C. | 2.5 (duplo) | 28-81 | 3 | 3 |
| 6 × HCl | 6 × Aqua Regia | Rt | 2.5 (duplo) | 46-50 | 15-18 | 22-23 |
| 6 × HCl | 6 × Aqua Regia | Rt | 5 (duplo) | 42 | 24-25 | 33-37 |
| 6 × HCl | 6 × H₂O₂/HCl | Rt | 2.5 (duplo) | 49 | 1-2 | 1-2 |
| 6 × HCl | 6 × Aqua Regia | 50° C. | 2.5 (duplo) | 54-55 | 17-19 | 22-28 |

The highest recovery percentages of iridium and platinum were acquired 6 times leaching with HCl, followed by 6 leaching procedures with aqua regia. 15-25% of iridium and 22-37% of platinum could be recovered using this method.

2.5. Extraction of iridium and platinum from Al/Ir/Pt beads at high temperature using aqua regia.

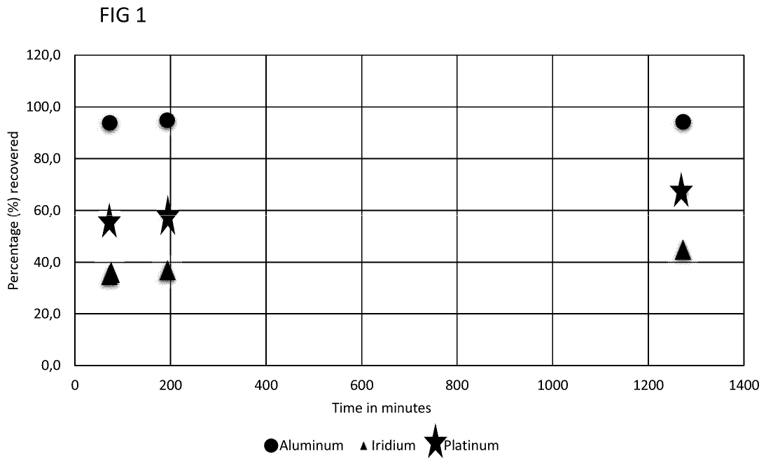

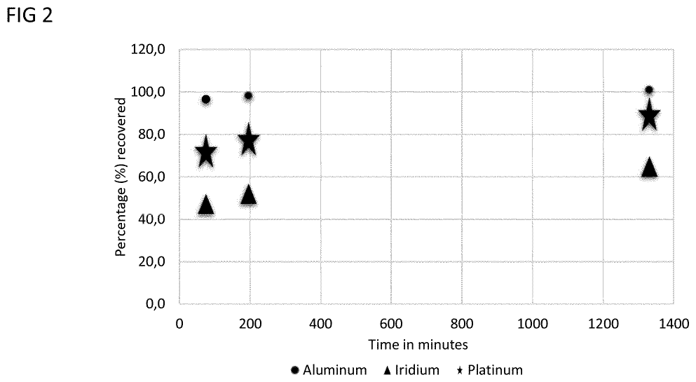

In a one-pot procedure Al/Ir/Pt beads were treated in tandem with 37% HCl and aqua regia at room temperature and reflux respectively. Using a standard reflux setup using a bead with 96% Al, after 24 h refluxing in aqua regia, 51% Ir and 71% Pt of the starting amounts could be recovered. From the same batch, beads were rewelded at a different current (A) and different welding times to explore whether an increase of the intermetallic alloy would possible lead to increased solubility. Excellent recovery of aluminum was observed for each rewelded bead, whereas a minimum of 37% iridium and 58.1% platinum recovery for a bead (FIG. 1) and a maximum of 52.2% iridium & 78% platinum recovery for a bead (FIG. 2) was achieved after 3 h of heating at reflux (˜115° C.).

### Example 3: Column Purification of Dissolved Beads

A column purification using AG 50W-X4 resin was carried out with a solution containing 10.7 mg Al, 1.12 mg Ir and 0.1 mg Pt for separation of the individual metals. The results are that 83.1-84,2% of Al, 40,4-41,8% of Ir and 16,4-22.2% of Pt were recovered after eluting with 1M HCl and 0.2M thiourea. Most of the Pt remained on the column.

### Example 4: Irradiation of Enriched ¹⁹³Ir

Quartz tubes with a length (inside diameter 0.7 mm, outside diameter 1.6 mm) varying between 20 to 47 mm were loaded with 78.1 to 1024.7 μg 94.34% ¹⁹³Ir using a Mettler Toledo microbalance. These tubes were cut and sealed. All tubes were placed in a graphite insert and irradiated in the High Flux Reactor Petten for two weeks. Subsequently, the activation of these samples was measured using gamma spectrometry. It was found that irradiation of 94.34% ¹⁹³Ir in a medium flux position in the HFR Petten, leads to ^{195m}pt with a specific activity of 13-17 GBq mg⁻¹ Pt (all isotopes generated).

It should be noted that in these experiments, the amount of Pt isotopes and ^{195m}pt, was significantly underestimated by the neutronic activation calculations using some of the common activation cross-section libraries, indicating significant uncertainty and underestimation in these libraries with regards to ¹⁹⁴Ir and ¹⁹⁵Ir neutron absorption cross-sections, which could go up to a factor 20.

### Example 5

Repetition of the experiments using Al/¹⁹³Ir beads gives ^{195m}Pt in goods yields and in certain cases higher than expected. This is attributed to the recoil effect due to which the Pt-isotope exits the Ir atomic environment and becomes embedded in the aluminium instead of the Ir and is hence easier to isolate in a higher yield.

1. A method for the production of platinum isotopes from iridium, comprising:
(a) providing a mixture of a carrier material and iridium (Ir);
(b) subjecting the carrier material-Ir mixture to a neutron flux to thereby generate an irradiated carrier material-Ir mixture comprising platinum (Pt) isotopes; and
(c) isolating Pt isotopes from the irradiated carrier material-Ir mixture.

2. The method according to claim 1, wherein the carrier material is selected from the group consisting of Al, Zr, Ti, In, Si, V, Sc, Mg, Ca, Pb and mixtures thereof.

3. The method according to claim 2, wherein the carrier material is selected from the group consisting of Al, Ti, Zr and mixtures thereof.

4. The method according to claim 1, wherein the carrier material-Ir mixture is a dispersion of Ir in the carrier material.

5. The method according to claim 4, wherein the dispersion is an atomic dispersion.

6. The method according to claim 1, wherein the Ir is dispersed in the carrier material in particles having an average particle or atomic cluster or precipitate size of less than 500 micron.

7. The method according to claim 6, wherein the Ir is dispersed in the carrier material in particles having an average particle or atomic cluster or precipitate size of less than 10 micron.

8. The method according to claim 1, wherein the carrier material-Ir mixture is an alloy or a compound of Ir and the carrier material and, optionally a metallic compound.

9. The method according to claim 1, wherein the carrier material-Ir mixture is prepared by melting carrier material and Ir together.

10. The method according to claim 1, wherein the melting is by means of a heat treatment.

11. The method according to claim 10, wherein the heat treatment is by welding.

12. The method according to claim 1, wherein the amount of Ir is from 0.5 to 50 wt. % calculated on the total weight of the mixture.

13. The method according to claim 1, wherein the amount of carrier material is from 50 to 99.5 wt. % calculated on the total weight of the mixture.

14. The method according to claim 1, wherein Ir is iridium enriched in ¹⁹³Ir.

15. The method according to claim 1, wherein the Pt isotopes comprise ^{195m}pt.

16. The method according to claim 1, wherein the carrier material is removed from the irradiated product.

17. The method according to claim 1, wherein the irradiated product is extracted with an extraction solvent.

18. The method according to claim 1, wherein the isolation comprises column chromatography.

19. The method according to claim 16, comprising a capture step of the ^{195m}pt on the column.

20. High specific activity ^{195m}Pt obtainable by the method of claim 1 having a specific activity of 13-17 GBq per mg Pt.
